(19) United States
(12) Patent Application Publication
(10) Pub. No.: US 2006/0279945 A1
(43) Pub. Date: Dec. 14, 2006

(54) BACKLIGHT UNIT MANUFACTURING METHOD, BACKLIGHT UNIT, ELECTRO-OPTICAL DEVICE, AND ELECTRONIC DEVICE

(75) Inventors: Hironori HASEI, Suwa (JP); Shigeo SAITO, Suwa (JP); Akira INAGAKI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/422,403

(22) Filed: Jun. 6, 2006

(30) Foreign Application Priority Data
Jun. 13, 2005 (JP) 2005-171957

(51) Int. Cl. G09F 13/04

(52) U.S. Cl. 362/97; 362/246; 362/330

(57) ABSTRACT

A backlight unit that includes: a light source emitting a light; and a diffuser plate that diffuses the light coming from the light source. In the backlight unit, the diffuser plate is provided with a plurality of ellipsoid-shaped microlenses, and disposed to make the microlenses and the light source intersect each other in each major axis direction.

### BACKGROUND

1. Technical Field

The present invention relates to a backlight unit manufacturing method, a backlight unit, an electro-optical device, and an electronic device.

2. Related Art

In a liquid crystal display device serving as an electro-optical device, a backlight unit equipped therein for use for a liquid crystal display has been often provided with an optical sheet formed with a plurality of microlenses. Such a configuration aims to efficiently guide light to liquid crystal elements, i.e., pixels, from an illumination light source of the backlight unit. The microlenses are formed by droplet ejection, which has been proposed by various techniques. As an exemplary technique, refer to a first example (JP-A-2004-157430).

The backlight unit has been of an edge light type (side light type) in which a light source, i.e., linear lamp, is disposed along the side surface of a light guide plate. For such an exemplary backlight unit, refer to a second example (JP-A-2004-309801). The second example describes the technique of forming a plurality of ellipsoid-shaped microlenses using a mold or others on a sheet exemplarily made of synthetic resin. As to the microlenses, one axis is longer than the other.

The problem with such a technique is that the screen intensity cannot be enough if with a large-size screen. This is due to the restrictions on the number of linear lamps allowed for installation. The weight of a light guide element also causes a difficulty in increasing the screen size. With a backlight unit of a direct type with which linear lamps are disposed in line immediately below the screen, the number of linear lamps can be increased depending on the screen size so that there is no problem in terms of the screen intensity. The issue here is that the linear lamps may have each different intensity, or the intensity may vary due to the intensity difference observed between portions with the linear lamps therebelow and portions without. The intensity variation is indeed reduced if the linear lamps are disposed away from the display surface. However, such a lamp disposition results in lower screen intensity, poorly lighted screen, and a difficulty in achieving lower-profile backlight unit. As such, to well light the screen, the number of linear lamps may be increased depending on the screen size, but the larger number of linear lamps often causes the problems of heat, cost, and others.

### SUMMARY

An advantage of some aspects of the invention is to provide a backlight unit manufacturing method that enables to manufacture a backlight unit that is with high brightness and varies less in intensity, a backlight unit with satisfactory optical properties, an electro-optical device, and an electronic device.

A first aspect of the invention is directed to a backlight unit including a light source emitting light, and a diffuser plate that diffuses the light coming from the light source. In the backlight unit, the diffuser plate is provided with a plurality of ellipsoid-shaped microlenses, and is disposed to make the microlenses and the light source intersect each other in their major axis directions.

In the backlight of the first aspect, the microlenses are so disposed as to intersect the light source in their major axis directions. As to such microlenses, the curvature in the minor axes is larger than that in the major axes so that the light is easily diffused in the minor axis direction, thereby favorably reducing the intensity variation. On the other hand, the light is hardly diffused in the major axis direction so that the brightness is increased. As such, the resulting backlight unit is with high brightness, and varies less in intensity.

In the first aspect, the backlight is preferably of a direct type.

If the backlight unit is of a direct type as such, the linear lamps are disposed between a reflector plate and a diffuser plate so that the light leakage can be reduced. The resulting backlight unit can be thus reduced in intensity variation to a further extent, and can be with high brightness.

In the backlight unit of the first aspect, the microlenses are preferably disposed in a staggered alignment.

If with a staggered alignment as such, the microlenses are to be densely packed on the substrate so that the light diffusibility is increased with more ease. The better light diffusibility accordingly reduces the intensity variation to a further extent, and reduces the light leakage to the outside. The resulting backlight unit thus can be with higher brightness.

In the backlight unit of the first aspect, the microlenses are preferably formed by droplet ejection.

If with the microlenses formed by droplet ejection as such, there is no more need to prepare a mold or others. This accordingly eliminates the cost for mold manufacturing, and thus is considered economical. What is better, even if the microlenses are changed in shape or layout configuration, there only needs to change the requirements for droplet ejection, thereby requiring little effort.

A second aspect of the invention is directed to a manufacturing method of a backlight unit including a light source emitting light, and a diffuser plate that diffuses the light coming from the light source. The method includes: forming the diffuser plate provided with a plurality of ellipsoid-shaped microlenses, and assembling the backlight unit with a disposition that the microlenses and the light source intersect each other in their major axis directions.

With the manufacturing method of the second aspect, in the backlight unit manufactured thereby, the microlenses are so disposed as to intersect the light source in their major axis directions. As to such microlenses, the curvature in the minor axes is larger than that in the major axes so that the light is easily diffused in the minor axis direction, thereby favorably reducing the intensity variation. On the other hand, the light is hardly diffused in the major axis direction so that the brightness is increased. As such, the resulting backlight unit is with high brightness, and varies less in intensity.

With the backlight unit manufacturing method of the second aspect, in the process of backlight unit assembly, the backlight unit is preferably assembled to be of a direct type.

If the backlight unit is assembled to be of a direct type as such, the linear lamps are disposed between a reflector plate and a diffuser plate so that the light leakage can be reduced. The resulting backlight unit varies much less in intensity, and can be with high brightness.

With the backlight unit manufacturing method of the second aspect, in the process of diffuser plate formation, the microlenses are preferably disposed in a staggered alignment.

If the microlenses are disposed in a staggered alignment as such, the microlenses are to be densely packed on the substrate so that the light to be diffused by the microlenses is increased. Such better light diffusibility accordingly reduces the intensity variation to a further extent, and reduces the light leakage to the outside. The resulting backlight unit thus can be with higher brightness.

With the backlight unit manufacturing method of the second aspect, in the process of diffuser plate formation, the microlenses are preferably formed by droplet ejection. The following are various procedures of forming a microlens by droplet ejection. In a first process, a lens-material droplet is disposed on a substrate, and before the droplet becomes rigid, another droplet is so disposed as to partially overlay the firstly-disposed droplet so that an ellipsoid-shaped droplet is formed. The resulting ellipsoid-shaped droplet is then made rigid. In a second process, a lens-material first droplet is disposed on a substrate, and the first droplet is made rigid so that a lens is formed. A second droplet less in amount than the first droplet is so disposed as to partially overlay the lens, and then the second droplet is made rigid so that the resulting lens is ellipsoid shaped. A third droplet is then disposed at the position opposite to the second droplet so as to partially overlay the ellipsoid-shaped lens, and the third droplet is made rigid. In a third process, a bank-material first droplet is disposed on a substrate, and the first droplet thus disposed on the substrate is made rigid so that the ellipsoid-shaped base is formed. On the resulting ellipsoid-shaped base, a lens-material second droplet is disposed, and the second droplet is made rigid. In a fourth process, a plurality of lens-material droplets are disposed with a space on a substrate, and the droplets are made rigid so that a plurality of lenses are formed. Between the resulting lenses, other droplets are disposed and then made rigid.

If the microlenses are formed by droplet ejection as such, there is no more need to prepare a mold or others. This accordingly eliminates the cost for mold manufacturing, and thus is considered economical. What is better, even if the microlenses are changed in shape or layout configuration, there only needs to change the requirements for droplet ejection, thereby requiring little effort. The microlens are thus manufactured with ease so that the productivity of the backlight unit can be accordingly improved.

A third aspect of the invention is directed to a diffuser plate for diffusing light. The diffuser plate is provided with a plurality of ellipsoid-shaped microlenses, which are disposed to direct in each different direction.

If the ellipsoid-shaped microlens is plurally disposed to direct in each different direction as such, the microlenses diffuse a larger amount of light so that the intensity variation is reduced, and the light leakage to the outside is also reduced. The resulting diffuser plate thus can be with high brightness.

A fourth aspect of the invention is directed to an electro-optical device including a liquid crystal panel and a backlight unit. The electro-optical device includes any of the above-described backlight units.

In the fourth aspect, if an electro-optical device is provided with a backlight unit that is high in brightness and varies less in intensity, the resulting electro-optical device accordingly is also high in brightness and varies less in intensity. Because a diffuser plate including ellipsoid-shaped microlenses can be easily formed by droplet ejection, the backlight unit and the electro-optical device can be both increased in productivity.

A fifth aspect of the invention is directed to an electronic device that includes the above-described electro-optical device.

In the fifth aspect, if the electronic device is provided with an electro-optical device that is high in brightness and varies less in intensity as such, the resulting electronic device can be increased in display performance. What is better, such an electro-optical device can be formed with ease so that the electronic device can be increased in productivity.

### BRIEF DESCRIPTION OF THE DRAWINGS

The invention will be described with reference to the accompanying drawings, wherein like numbers reference like elements.

FIG. 1 is a schematic perspective view of an exemplary backlight unit in an embodiment of the invention.

FIG. 2 is a diagram sowing an exemplary diffuser plate.

FIG. 3 is a diagram showing exemplary assembly of a backlight unit.

FIG. 4 is a diagram for illustrating the principle of ejecting a liquid material utilizing the piezo technology.

FIGS. 5A to 5D are all a diagram showing the method of forming an ellipsoid-shaped microlens.

FIGS. 6A to 6G are all a diagram showing the method of forming an ellipsoid-shaped microlens.

FIGS. 7A to 7F are all a diagram showing the method of forming an ellipsoid-shaped microlens.

FIGS. 8A to 8E are all a diagram showing the method of forming an ellipsoid-shaped microlens.

FIG. 9 is a diagram showing a specific example of a liquid crystal display device.

FIG. 10 is a diagram showing a mobile phone serving as an electronic device.

### DESCRIPTION OF EXEMPLARY EMBODIMENT

### Embodiment

In this embodiment, described is a backlight unit provided with a diffuser plate that includes an ellipsoid-shaped microlens formed on a substrate by droplet ejection. In the backlight unit, the ellipsoid-shaped microlens is so disposed as to diagonally intersect a linear lamp in their major axis directions.

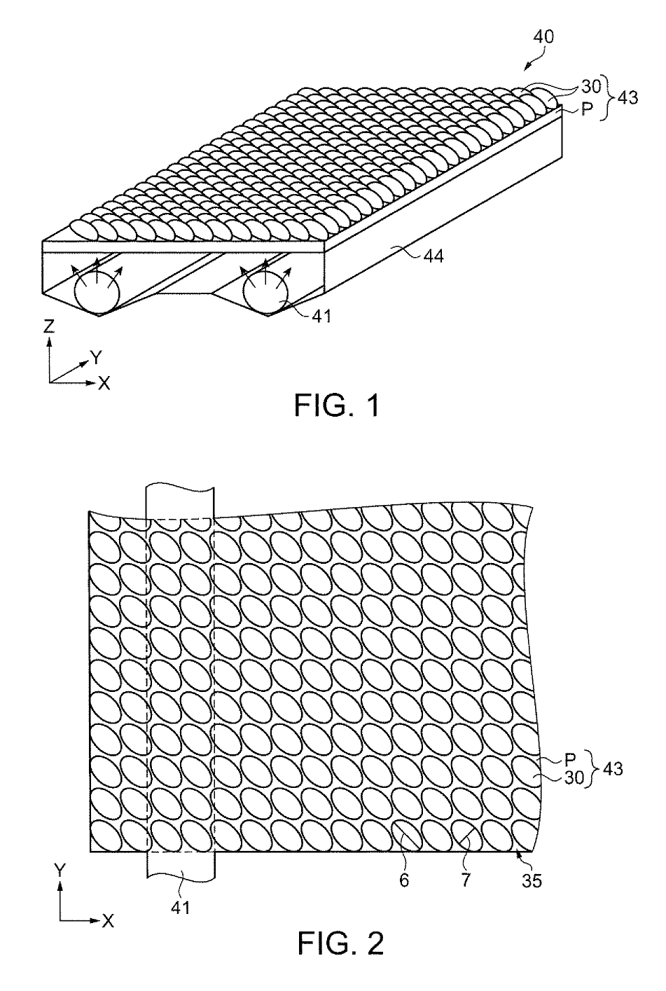

FIG. 1 is a schematic perspective view of an exemplary backlight unit 40 of the embodiment. By referring to FIG. 1, the backlight unit 40 of the invention will be described.

As shown in FIG. 1, the backlight unit 40 is of a direct type. The backlight unit 40 is configured to include a linear lamp 41 serving as a light source, a diffuser plate 43 for diffusing light coming from the linear lamp 41, and a reflector plate 44 for reflecting the light. The diffuser plate 43 is formed with a plurality of ellipsoid-shaped microlenses 30 on a substrate P. The linear lamp 41 is plurally provided, e.g., two in this example. The linear lamps 41 are disposed between the reflector plate 44 and the diffuser plate 43, and light coming from such linear lamps 41 is guided to the backside of the substrate P.

The backlight unit 40 is configured as such, and described now is light irradiation in the backlight unit 40.

When the linear lamps 41 are turned on, light comes from the linear lamps 41, and the light is guided to the back surface side of the substrate P. The light coming from the linear lamps 41 is partially reflected by the reflector plate 44, and the reflected light is directed to the substrate P. The light entered to the substrate P, i.e., the guided light and the reflected light, is diffused by the ellipsoid-shaped microlenses 40 before exiting therefrom. Note here that the light entered to the substrate P is reflected by a pattern (not shown) formed on the back surface side of the substrate P. This pattern is so disposed that the light amount is made uniform in the surface when the light passes through the substrate P (not shown).

FIG. 2 is a diagram showing an exemplary diffuser plate 43 in the embodiment. By referring to FIG. 2, the diffuser plate 43 of the invention will be described.

As shown in FIG. 2, the diffuser plate 43 is provided with the substrate P, and a plurality of ellipsoid-shaped microlenses 30 (microlens array 35) on the surface P.

The substrate P is made of synthetic resin that is transparent, especially colorless transparent so as to pass through light beams. The synthetic resin for use for the substrate P is not specifically restricted, and includes polyethylene terephthalate, polyethylene naphthalate, acrylic resin, polycarbonate, polystyrene, polyolefin, cellulose acetate, weather-resistant polyvinyl chloride, radiation curing resin, and others.

The thickness (average thickness) of the substrate P is not specifically restricted, and is set to 10 μm or thicker but 500 μm or thinner, for example. The thickness of the substrate P is preferably 35 μm or thicker but 250 μm or thinner, more preferably, 50 μm or thicker but 188 μm or thinner. If the thickness of the substrate P is falling below such ranges, this causes a problem that the substrate P is easily curled in the backlight unit or others when exposed to heat, a problem of handling difficulty, and others. On the other hand, when the thickness of the substrate P exceeds the values of the ranges, this often reduces the intensity of a liquid crystal display device, and increases the thickness of the backlight unit. This goes against the demands for thinner-profile liquid crystal display device.

The microlens array 35 is configured by a plurality of ellipsoid-shaped microlenses 30 that protrude through the surface of the substrate P. The ellipsoid-shaped microlenses 30 are all convex.

The ellipsoid-shaped microlenses 30 are so disposed as to intersect the linear lamps 41 in their major axis directions. The angle of intersection is about 45 degrees, and the major axis direction is directed from the lower right (upper left) toward the upper left (lower right) of the substrate P of FIG. 2.

The ellipsoid-shaped microlens 30 has a major axis 6 and a minor axis 7. With such an ellipsoid-shaped microlens 30, the curvature in the minor axis direction is larger than that in the major axis direction so that the light is easily diffused in the minor axis direction, thereby favorably reducing the intensity variation. On the other hand, the light is hardly diffused in the major axis direction of the ellipsoid-shaped microlens 30 so that the brightness is easily increased.

The ellipsoid-shaped microlens 30 is geometrically disposed on the surface of the substrate P with rather high density. More specifically, the ellipsoid-shaped microlens 30 is disposed in a staggered alignment on the surface of the substrate P, and the pitch and the lens-to-lens interval are both constant. Such a staggered alignment pattern enables to dispose the microlenses 30 in the shape of ellipsoid when viewed from above with the highest placement density, thereby favorably increasing the optical capabilities of the diffuser plate 43, e.g., light gathering, light diffusion, or others.

With such a staggered alignment on the substrate P in which the ellipsoid-shaped microlenses 30 are disposed with the high placement density, the microlenses 30 fully occupy on the substrate P with little unoccupied space left. Therefore, the light passing through the microlenses 30 is increased, and the light diffusibility is increased with more ease. The resulting backlight unit 40 (refer to FIG. 1) can be higher in brightness because of the less intensity variation and the less light leakage to the outside.

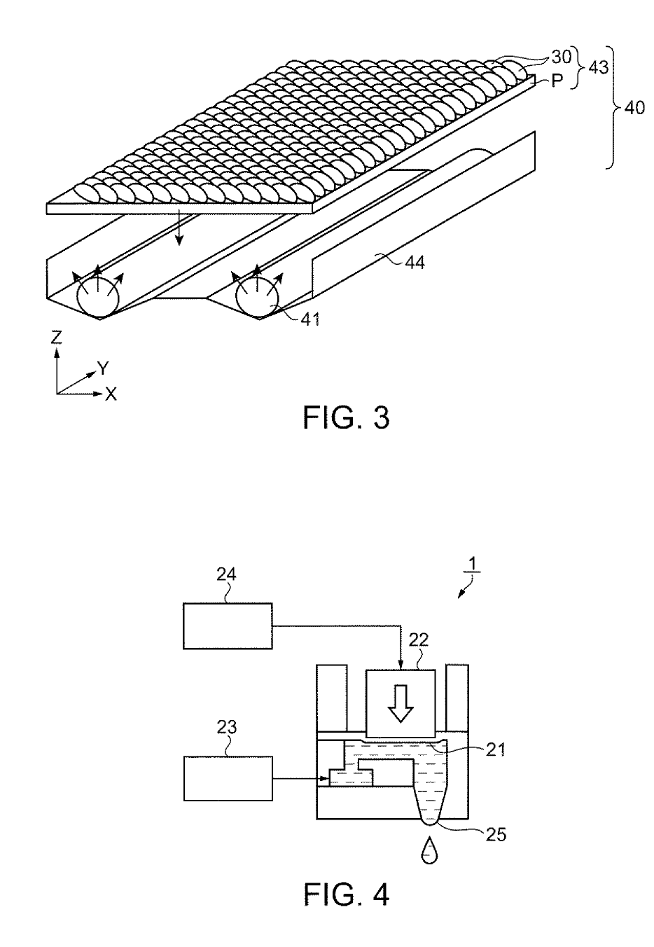

FIG. 3 is a diagram showing exemplary assembly of the backlight unit 40 in the embodiment. By referring to FIG. 3, described now is the assembly of the backlight unit 40 of the invention.

As shown in FIG. 3, the reflector plate 44 disposed with the linear lamps 41 is engaged with the diffuser plate 43 so that the backlight unit 40 is assembled. For example, the reflector plate 44 is disposed with the diffuser plate 43 so that the backlight unit 40 is assembled. The resulting backlight unit 40 is of the one shown in FIG. 1. The backlight unit 40 has less intensity variation and is higher in brightness, and thus there is no need to increase the number of the linear lamps 41 to make those serve as a light source. The problems of heat, cost, and mass of the linear lamps 41 can be thus almost cleared, thereby resulting in the backlight unit 40 much lighter in weight. What is better, the linear lamps 41 can be disposed closer to the display surface so that the backlight unit 40 can be made thinner in profile.

Described next are, one by one, droplet ejection, surface treatment, materials for banks and microlenses, and curing treatment to such bank and microlens materials, all of which are for use for droplet ejection of forming the ellipsoid-shaped microlenses 30.

### Droplet Ejection

For droplet ejection, possible techniques include electrification control, pressure oscillation, electrical-mechanical conversion, electrothermal conversion, electrostatic suction, and others. Herein, with electrification control, a material is charged by a charging electrode, and a deflection electrode exercises control over the dispersion direction of the material so that the material is ejected from an ejection nozzle. With pressure oscillation, a material is applied with an ultra high pressure of about 30 kg/cm², and is ejected to the side of the nozzle tip end. With no control voltage applied, the material goes straight, and is ejected from the ejection nozzle. With a control voltage applied, an electrostatic repulsion occurs in the material, and thus the material is scattered over and not ejected from the ejection nozzle. With electrical-mechanical conversion, utilized are the characteristics of a piezo element (piezo-electric device), deforming in response to a pulse-like electric signal. Through deformation of the piezo element, a pressure is applied to a space filled with a material via a flexible substance so as to push the material from the space, and the material is thus ejected from the ejection nozzle.

With electrothermal conversion, using a heater equipped in a space filled with a material, the material is quickly vaporized to generate bubbles, and the material in the space is ejected by the bubble pressure. With electrostatic suction, a slight pressure is applied to a space filled with a material, and an ejection nozzle is formed with a meniscus of the material. In this state, the material is withdrawn after electrostatic attraction is applied thereto. There are some other techniques, e.g., utilizing viscosity change of fluid in an electric field, utilizing discharge spark for scattering, or others. The droplet ejection has an advantage of little material waste, and precise disposition of any desired amount of material at any desired position. Note that a droplet of a liquid material is 1 to 300 nanograms to be ejected by droplet ejection, for example.

FIG. 4 is a diagram for illustrating the principle of ejecting a liquid material by the piezo technology.

In FIG. 4, a piezo element 22 is disposed adjacent to a liquid chamber 21 storing therein a liquid material. The liquid chamber 21 is provided with a liquid material via a liquid material supply system 23 including a material tank for storage of the liquid material. The piezo element 22 is connected to a drive circuit 24, and through this drive circuit 24, applies a voltage to the piezo element 22 for deformation thereof. Due to the deformed piezo element 22, the liquid chamber 21 is also deformed so that the liquid material is ejected from an ejection nozzle 25. In this case, the piezo element 22 is controlled by deformation level through voltage change for application. Through frequency change of voltage application, the piezo element 22 is controlled by deformation speed. Such droplet ejection utilizing the piezo technology does not heat the material so that the material composition is not affected that much.

### Surface Treatment

For possible surface treatment, exemplified is a method of forming an organic thin film on the substrate surface for liquid repellency aiming control over a contact angle of droplet, a plasma treatment, or others. To achieve such a liquid repellent treatment smoothly, washing of a pretreatment process is considered preferable, e.g., ultraviolet (UV) wash, UV/ozone wash, plasma wash, acid or alkaline wash, or others.

In the method of forming an organic thin film for the liquid repellent treatment, an organic thin film is formed to the substrate surface before a wiring pattern is formed thereonto. For such film formation, used are organic molecules, e.g., silane compound, surface-active agent, or others.

The organic molecules for use for substrate surface treatment include two functional groups; one can be physically or chemically bonded to the substrate, and the other can reform the property of the-other-side substrate surface (control the surface energy), e.g., lyophilic group, liquid repellent group, or others. Such organic molecules are bonded to the substrate so that an organic film, ideally, a monomolecular film is formed. In particular, organic molecules of a specific organic structure form a densified self-assembled film through self assembly by bonding to the substrate. The specific organic structure is of linear-carbon chains or partially-branched carbon chains, linking between a functional group bondable to the substrate and a functional group reforming the other side surface of the substrate.

Herein, the self-assembled film is formed through alignment of a compound, which has a considerably-high-level alignment property. The compound includes a bonding functional group that is reactive to atoms of the base layer or others of the substrate, other linear chains of atoms, and aromatic ring systems. The considerably-high-level alignment property is derived as a result of Van der Waals interaction in the linear chains of atoms, or π-π stacking between aromatic rings. Such a self-assembled film is a monomolecular film, and the film thickness can be thus considerably reduced and be uniform down to a molecular level. That is, because the film surface carries thereon the same type of molecules, the film surface can be uniformly liquid repellent or lyophilized with a high level of excellence.

The compound with a high-level alignment property is exemplified by a silane compound represented by a general formula of R¹SiX¹ₐX²₍₃₋ₐ₎. In the formula, R¹ denotes an organic group, X¹ and X² denote —0R², —R², and —C1, and R² in X¹ and X² denotes an alkyl group with the carbon number of 1 to 4, and a denotes an integer of 1 to 3.

In the silane compound represented by the general formula of R¹SiX¹ₐX²₍₃₋ₐ₎, silane atoms are substituted by an organic group, and the remaining bonding group is substituted by an alkoxy group, an alkyl group, or a chlorine group. The organic group R¹ is exemplified by groups of phenyl, benzyl, phenethyl, hydroxyphenyl, chlorophenyl, aminophenyl. naphthyl, anthranyl, pyrenyl, thienyl, pyrrolyl, cyclohexyl, cyclohexenyl, cyclopentyl, cyclopentenyl, pyridinyl, methyl, ethyl, n-propyl, isopropyl, n-butyl, isobutyl, sec-butyl, tert-butyl, octadecyl, n-octyl, chloromethyl, methoxyethyl, hydroxyethyl, aminoethyl, cyano, mercaptopropyl, vinyl, aryl, acryloxyethyl, methacryloxyethyl, glycidoxypropyl, acetoxy, and others.

The alkoxy group or the chlorine group denotes by X¹ is a functional group for establishing Si—O—Si bonding, for example, and is eliminated as alcohol or acid after water hydrolysis. The alkoxy group is exemplified by groups of methoxy, ethoxy, n-propoxy, isopropoxy, n-butoxy, isobutoxy, sec-butoxy, tert-butoxy, and others.

The carbon number of R² is preferably in a range from 1 to 4. This is because the molecular weight of to-be-eliminated alcohol is relatively low, and thus removing alcohol molecules is easy, and the densification of the resulting film is not impaired.

The typical liquid-repellent silane compound represented by the general formula of R¹SiX¹ₐX²₍₃₋ₐ₎ is exemplified by a fluorine-bearing alkylsilane compound. In the formula, R¹ denotes an organic group of a structure represented by a perfluoroalkyl structure, i.e., CₙF₂ₙ₊₁, and n denotes an integer from 1 to 18. By using the fluorine-bearing alkylsilane compound, a self-assembled film is formed through compound alignment in such a manner that the fluoroalkyl group is disposed on the film surface. The resulting self-assembled film can be uniformly liquid repellent on the surface.

The silane compound including a fluoroalkyl group or is of a perfluoroalkyl ether structure is collectively referred to as “FAS”. Such compounds may be each used solely, or with varying combinations of two or more compounds. Using such FAS favorably leads to good adhesion to the substrate and excellent liquid repellency.

The compound with a high-level alignment property is not restrictive to such a silane compound, and, a surface-active agent represented by a general formula of R¹Y¹ is also a possible option. In the formula of R¹Y¹, R¹ denotes a hydrophobic organic group, and Y¹ is a hydrophilic polar group, —OH, —(CH2CH2O)nH, —COOH, —COOA, —CONH2, —SO3H, —SO3A, —OSO3H, —OSO3A, —PO3H2, —PO3A, —NO2, —NH2, —NH3B (ammonium salt), ≡NHB (pyridinium salt), —NX¹₃B (alkylammonium salt), or others. Herein, A denotes one or more positive ions, B denotes one or more negative ions, and X¹ denotes an alkyl group with the carbon number of 1 to 4 similarly to the above.

The surface-active agent represented by the general formula of R¹Y¹ is an amphiphilic compound in which a lipophilic organic group R¹ is bonded with a hydrophilic functional group. In the formula, Y¹ denotes a hydrophilic polar group, which is a functional group serving for bonding with the substrate or absorption thereto. The organic group R¹ has the lipophilic property, and when the group is disposed on the opposite side to the hydrophilic surface, the hydrophilic surface is formed thereon with a lipophilic surface.

The typical liquid-repellent silane compound represented by the general formula of X¹Y¹ is exemplified by a fluorine-bearing alkyl surface-active agent. In the formula, R¹ is an organic group of a structure represented by a perfluoroalkyl structure, i.e., CₙF₂ₙ₊₁, or a perfluoroalkyl ether structure, and n denotes an integer from 1 to 18.

Such a surface-active agent of a perfluoroalkyl structure or a perfluoroalkyl ether structure may be used solely, or with varying combinations of two or more. Using such a surface-active agent including the perfluoroalkyl group favorably leads to good adhesion to the substrate and excellent liquid repellency.

Alternatively, the alkyl structure with no fluoride is also a possibility, and with this being the case, forming a densified film also to a surface-active agent of a general type will provide the liquid repellency.

To form an organic thin film from organic molecules such as a silane compound or a surface-active agent on the substrate P, the base compound is put into a sealed container together with the substrate P, and is left for about a few days in the room temperature. If the sealed container is placed in the environment of 80 to 140 degrees in temperature, the film is formed on the substrate in about an hour to three. Such a self-assembled film can be formed not only by vapor phase as such but also by liquid phase. As an exemplary formation technique, a substrate is soaked in the solution of a base compound for 30 minutes to 6 hours. After soaking, the substrate is washed and then dried so that a self-assembled film is formed on the substrate. If the solution of the base compound is heated to 40 to 80 degrees in temperature, the soaking time will be shortened to 5 minutes to 2 hours for formation of a self-assembled film.

With plasma treatment, the substrate P is exposed to plasma under a normal pressure or in a vacuum. The gas type for such plasma treatment has various options for selection in consideration of the surface material or others of the substrate P to be formed with a wiring pattern. A suitable option for the gas for treatment use is a fluorocarbon compound, e.g., tetrafluoromethane, perfluorohexane, perfluorodecan, or others. The requirements for plasma treatment using a tetrafluoromethane gas (CF₄ plasma treatment) are the plasma power of 50 to 1000 W, the flow rate of 50 to 100 mL/min for a carbon tetrafluoride gas, the substrate transfer speed of 0.5 to 1020 mm/sec with respect to a plasma discharge electrode, and the substrate temperature of 70 to 90 degrees, for example.

### Bank Material

The bank material is not specifically restrictive as long as being liquid ejectable in droplet at the time of formation, and being curable after ejected. Such a material includes the one in which a solvent is removed after coating of a resin-dissolved solution, or various types of resin and p article, e.g., thermoplastic resin, thermosetting resin, photocurable resin, resin solution, particle dispersant, or others.

The generally-used bank material includes an organic material such as polyimide, acrylic resin, or novolac resin. These are not surely the only options, and other possible options are oligomers or polymers, e.g., polyvinyl alcohol, unsaturated polyester, methyl methacrylic resin, polyethylene, diallyl phthalate, ethylene propylene diene monomer, epoxy resin, phenolic resin, polyurethane, melamine resin, polycarbonate, polyvinyl chloride, polyamide, styrene butadiene rubber, chloroprene rubber, polypropylene, polybutylene, polystyrene, polyvinyl acetate, polyester, polybutadiene, polybenzimidazole, polyacrylonitrile, epichlorohydrin, polysulfide, polyisoprene, and others.

The bank material is preferably a curable resin that is made rigid by light or heat. This is because the bank material is not allowed to dissolve in or react to resin or solution that will come into contact therewith.

Such a photocurable resin is derived by curing a resin composition that generally includes at least one or more functional groups, monomers and oligomers, and a photopolymerization initiator. Herein, the monomers and oligomers take charge of ionic polymerization or radical polymerization using ions or radicals generated as a result of light exposure to the photopolymerization initiator, and increase the molecular weight. If required, crosslinks are formed thereby. The functional group here denotes an atom's mass or a bonding scheme that is a cause of reaction of vinyl group, carboxyl group, amino group, hydroxyl group, epoxy group, or others.

The thermosetting resin is derived by curing a resin composition that generally includes at least one or more functional groups, monomers and oligomers, and a thermal polymerization initiator. Herein, the monomers and oligomers take charge of ionic polymerization or radical polymerization using ions or radicals generated as a result of heat application to the thermal polymerization initiator, and increase the molecular weight. If required, crosslinks are formed thereby. The functional group here denotes an atom's mass or a bonding scheme that is a cause of reaction of vinyl group, carboxyl group, amino group, hydroxyl group, epoxy group, or others.

If with a resin solution such as varnish, a highly-heat-resistant polymer, e.g., polyimide, is previously dissolved, and is dried for precipitation. The resulting material can be used for bank formation without the need for curing by light or heat.

Alternatively, a particle dispersant can be used as is leading to the heat resistance and excellent light transmission. The particles are exemplified by silica, alumina, titania, calcium carbonate, aluminum hydroxide, acrylic resin, organic silicone resin, polystyrene, urea resin formaldehyde condensate, and others. Any one of these types of particles may be solely used, or a plurality of types may be combined together for use. When the material selected for use is particles, the particles are flocculated after dried and sedimented for use as a bank. The surfaces of the particles may be subjected to surface treatment for provision thereto of photosensitization or thermosensitization. This is aimed to increase the adhesion between the particles, and between the substrate particles.

To the extent not impairing any target capability, the droplets of the bank material may be added with a very small amount of a surface tension control agent of fluorine, silicone, nonion, or others. Such a surface tension control agent serves well to enable control over the wettability to a coating object, to improve the leveling of the coated film, and to prevent the irregularities or orange peel on the coated film, for example.

As to the droplets of the bank material prepared as such, the viscosity is preferably of 1 to 50 mPa·s. When the solution is coated using a droplet ejection device, if the viscosity is lower than 1 mPa·s, the nozzle and its neighboring area are easily contaminated as a result of flow of droplets. When the viscosity is higher than 50 mPa·s, the nozzle hole is frequently clogged, resulting in a difficulty in smooth droplet ejection. More preferably, the viscosity is of 5 to 20 mPa·s.

Also as to the droplets of the bank material prepared as such, the surface tension is preferably of 1 to 50 mPa·s. This surface tension desirably falls within the range from 0.02 to 0.07 N/m. When the solution is coated using a droplet ejection device, if the surface tension is lower than 0.02 N/m, the wettability of the droplets is increased with respect to the nozzle surface, thereby easily resulting in ink deflection. When the surface tension exceeds 0.07 N/m, the meniscus shape at the nozzle tip is not stabilized, thereby resulting in a difficulty in controlling the droplets in terms of ejection amount and timing.

### Microlens Material

The material for the ellipsoid-shaped microlenses 30 is not specifically restrictive as long as being liquid ejectable in droplet at the time of formation, being curable after ejected, and being light-transmissive for the light while serving as a lens after cured. Such a resin includes the one in which a solvent is removed after coating of a light-transmissive-resin-dissolved solution, or various types of resin and particle, e.g., thermoplastic resin, thermosetting resin, photocurable resin, or others. The photosetting resin is considered preferable as is easily and swiftly cured, and as not increasing the temperature of a lens formation material and a base material when cured.

Such a photocurable resin is derived by curing a resin composition that generally includes at least one or more functional groups, monomers and oligomers, and a photopolymerization initiator. Herein, the monomers and oligomers take charge of ionic polymerization or radical polymerization using ions or radicals generated as a result of light exposure to the photopolymerization initiator, and increase the molecular weight. If required, crosslinks are formed thereby. The functional group here denotes an atom's mass or a bonding scheme that is a cause of reaction of vinyl group, carboxyl group, hydroxyl group, or others.

Such monomers and oligomers are exemplarily of unsaturated polyester type, enethiol type, acrylic type, and others. In particular, the acrylic type is considered preferable in view of a wide choice of the curing speeds and physical properties. As to such acrylic monomers and oligomers, a monofunctional group is exemplified by 2-ethylhexyl acrylate, 2-ethylhexyl EO adduct acrylate, ethoxydiethylene glycol acrylate, 2-hydroxyethyl acrylate, 2-hydroxypropyl acrylate, caprolactone adduct of 2-hydroxyethyl acrylate, 2-phenoxyethyl acrylate, phenoxydiethylene glycol acrylate, nonylphenol EO adduct acrylate, acrylate of caprolactone-added nonylphenol EO adduct, 2-hydroxy-3-phenoxypropyl acrylate, tetrahydrofurfuryl acrylate, caprolactone adduct acrylate of furfuryl alcohol, acryloylmorpholine, dicyclopentenyl acrylate, dicyclopentenyl acrylate, dicyclopentenyloxyethyl acrylate, isobonyl acrylate, acrylate of caprolactone adduct of 4,4-dimethyl-1,3-dioxolane, acrylate of caprolactone adduct of 3-methyl-5, 5-dimethyl-1, 3-dioxolane, and others.

As to the acrylic monomers and oligomers, a polyfunctional group is exemplified by hexanediol acrylate, neopentyl glycol diacrylate, polyethylene glycol diacrylate, tripropylene glycol diacrylate, hydroxypivalic acid neopentylglycolester diacrylte, caprolactone adduct diacrylate of hydroxypivalic acid neopentylglycolester, acrylic acid adduct of diglycidyl ether of 1,6-hexanediol, diacrylate of acetal compound of hydroxylpivalaldehyde and trimethylolpropane, 2,2-bis[4-(acryloyloxy-diethoxy)phenyl]propane, 2,2-bis[4-(acryloyloxy-diethoxy)phenyl]methane, diacrylate of hydrogenated bisphenol ethylene oxide adduct, tricyclodecane dimethanol diacrylate, trimethylol propane triacrylate, pentaerythritol triacrylate, trimethylol propane propylene oxide adduct triacrylate, glycerol propylene oxide adduct triacrylate, dipentaerythritol hexaacrylate pentaacrylate mixture, caprolactone adduct acrylate of dipentaerythritol, tris(acryloyloxy ethyl)isocyanate, 2-acryloyloxy ethyl phosphate, and others.

To the light-transmissive resin, light diffusing particles may be previously mixed and dispersed. The light diffusing particles are exemplified by particles of silica, alumina, titania, calcium carbonate, aluminum hydroxide, acrylic resin, organic silicone resin, polystyrene, urea resin, formaldehyde condensate, and others. Any one of these types of particles may be solely used, or a plurality of types may be combined together for use. Note here that, for the light diffusing particles to fully make use of their light diffusion property, when the selected particles are light transmissive, the refraction index thereof is required to be sufficiently different from that of the light-transmissive resin. In consideration thereof, when the selection options for the light diffusing particles are light transmissive, the selection is to be appropriately made in accordance with the light-transmissive resin for use to satisfy the above-described requirements.

Such light diffusing particles are previously dispersed into the light-transmissive resin as described above, and thus are prepared to be liquid to be ready for ejection from the droplet ejection head. In this case, preferably, the surfaces of the light diffusing particles are coated by a surface-active agent, or coated by a dissolved resin so as to increase the diffusibility of the light diffusing particles with respect to the light-transmissive resin. Through such surface treatment, the light-transmissive resin including therein the dispersed light diffusing particles can be provided with the flowability so that the ejection from the droplet ejection head becomes smooth. Herein, the surface-active agent for such surface treatment available for selection includes agents of cation, anion, nonion, dipolar, silicone, fluorine resin, and others, which are selected based on the type of the light diffusing particles.

For such light diffusing particles, the particle size is preferably 5 nm or larger but 1000 nm or smaller. More preferably, the particle size is of 200 nm or larger but 500 nm or smaller. Such a particle size of 200 nm or larger enables to keep good the light diffusibility, and the particle size of 500 nm or smaller leads to smooth ejection from the nozzle of the droplet ejection head.

If such a light-transmissive rein including therein the dispersed light diffusing particles is used for formation of the ellipsoid-shaped microlenses 30, the resulting microlenses are all much higher in diffusibility as are provided with various functions by the light diffusing particles. The microlenses 30 are also excellent in heat resistance as are reduced in thermoplasticity.

In consideration of such a fact that heat resistance and excellent light transmission are derived, a resin including inorganic components is also an option for use. Specifically exemplified is silicon, germanium, titanium, or others, and in terms of availability, a resin including silicon is considered preferable.

Such polymers include polysiloxane, polysilane, polysilazane, or others. These compounds include silicon skeleton in the polymer main chains, and in response to chemical reaction, e.g., heat, light, or catalyst, form a silicon oxide similar to glass. The silicon oxide formed as such is suitable for the microlens material thanks to the excellent heat resistance and light transmission compared with any resin including only an organic material, for example.

More in detail, the silicon oxide can be derived first by ejecting a polysiloxane solution including an alkoxy group together with a catalyst, and then by condensing the alkoxy group through drying and heating. Alternatively, the silicon oxide can be derived first by ejecting a polysilane solution, and then by exposing the polysilane to ultraviolet rays for photoxidation of the polysilane. Still alternatively, the silicon oxide can be derived first by ejecting a polysilazane solution, and then by subjecting the polysilazane to hydrolysis by ultraviolet rays, acid, alkali, or others, and then to oxidation.

To the extent not impairing any target capability, a microlens-material ink may be added with a very small amount of a surface tension control agent of fluorine, silicone, nonion, or others. Such a surface tension control agent serves well to enable control over the wettability of the ink with respect to a coating object, to improve the leveling of the coated film, and to prevent the irregularities or orange peel on the coated film, for example.

As to the droplets of the microlens material prepared as such, the viscosity is preferably of 1 to 50 mPa·s. When the solution is coated using a droplet ejection device, if the viscosity is lower than 1 mPa•s, the nozzle and its neighboring area are easily contaminated as a result of flow of droplets. When the viscosity is higher than 50 mPa·s, the nozzle hole is frequently clogged, resulting in a difficulty in smooth droplet ejection. More preferably, the viscosity is of 5 to 20 mPa·s.

Also as to the droplets of the microlens material prepared as such, the surface tension is preferably of 1 to 50 mPa·s. This surface tension desirably falls within the range from 0.02 to 0.07 N/m. When the solution is coated using a droplet ejection device, if the surface tension is lower than 0.02 N/m, the wettability of the droplets is increased with respect to the nozzle surface, thereby easily resulting in ink deflection. When the surface tension exceeds 0.07 N/m, the meniscus shape at the nozzle tip is not stabilized, thereby resulting in a difficulty in controlling the droplets in terms of ejection amount and timing.

Curing Treatment for Bank Material and Microlens Material

The curing treatment for a bank material and a microlens material includes heat treatment and/or light treatment. The curing treatment is often applied in the air, and as required, is applied in an inert atmosphere, e.g., nitrogen, argon, helium, or others. The requirements for the heat treatment and/or light treatment are appropriately determined in consideration of the boiling point (vapor pressure) of a solvent, the type and pressure of ambient gas, the reaction temperature or reaction exposure of a polymerization initiator, the reaction temperature or reaction exposure of crosslink reaction, the glass transformation temperature of oligomers and polymers, the heat-resistant temperature of a base material, the dispersion capability of particles, the thermal behavior such as oxidation, and others.

With the light treatment, the microlens material can be made rigid for formation using ultraviolet rays, far ultraviolet rays, electron beams, X-rays, and others, which are each preferably 1 J/cm² or lower, or 0.2 j/cm² or lower if aiming for productivity increase. With the heat treatment, possibly used is a hot plate or an electric furnace. Lamp annealing is also a possibility, and if with the glass transformation temperature or lower for a curing object, the temperature is preferably 200 degrees or lower. If with the glass transformation temperature or higher, there is a possibility that the curing object is deformed to the shape with lower curvature due to heat.

Next, described briefly is the formation method for the ellipsoid-shaped microlens 30. The first to fourth formation methods are described below.

### First Formation Method

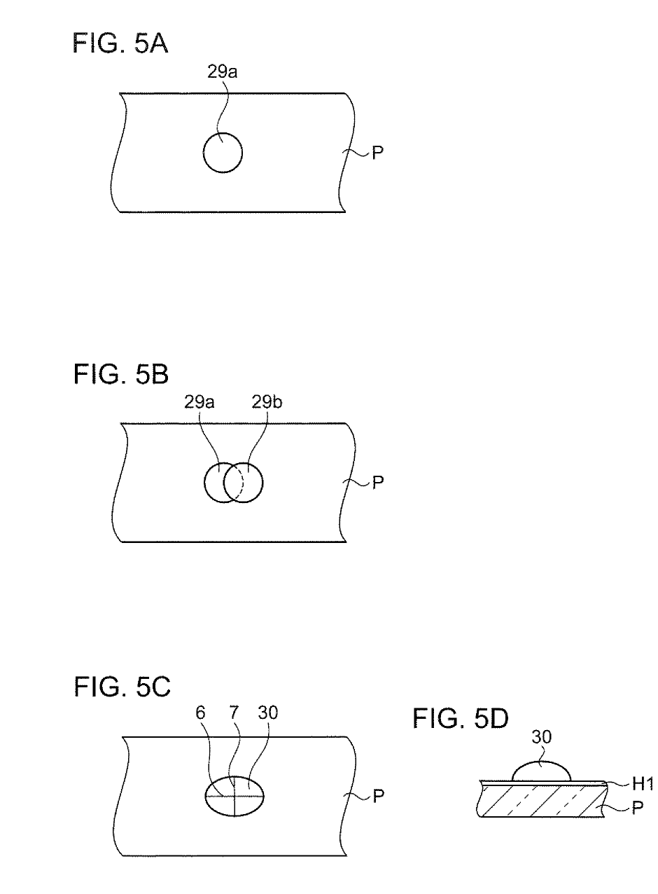

FIGS. 5A to 5D are all a diagram showing the formation method for the ellipsoid-shaped microlens 30. By referring to FIGS. 5A to 5D, described is the formation method of the ellipsoid-shaped microlens 30 by droplet ejection. The first formation method includes processes of disposing a lens-material droplet on a substrate, forming an ellipsoid-shaped droplet by disposing another droplet to partially overlay the firstly-disposed droplet before the droplet becomes rigid, and curing the resulting ellipsoid-shaped droplet.

For a smooth liquid repellent treatment to the substrate P, washing the substrate P is considered preferable as a pretreatment process of the liquid repellent treatment. The substrate P may be washed through ultraviolet (UV) wash, UV/ozone wash, plasma wash, acid or alkaline wash, or others.

The surface of the substrate P is then subjected to surface treatment. For the surface treatment to the substrate P, the surface of the substrate P is made to be liquid repellent aiming to derive any needed contact angle, to reduce the diameter of the ejected lens-material droplet, i.e., lens diameter. To make the surface of the substrate P liquid repellent, formation of an organic thin film on the surface of the substrate P, plasma treatment, or others will do. In this example, an organic thin film is formed, and as a result, the surface of the substrate P is made liquid repellent.

In the process of disposing a lens-material droplet, a microlens material is ejected from the droplet ejection head 1 on the liquid-repellent substrate P, and a droplet 29a is disposed (refer to FIG. 5A). The requirements for such droplet ejection are the weight of a droplet being 4 ng/dot, and the speed of a droplet, i.e., ejection speed, being 5 to 7 m/sec, for example. The atmosphere for droplet ejection is preferably set to the temperature of 60 degrees or lower and the humidity of 80% or lower. If such requirements are satisfied, the droplet ejection can be performed with stability with no clogging of an ejection nozzle of the droplet ejection head 1. The microlens material is not restrictive to the solution of a photosetting resin, and the solution of a thermosetting resin is also a possibility. The resin may be a polymer resin or a monomer resin. If with a monomer liquid, as an alternative to a solution, the monomer liquid itself may be used, or a polymer solution that is not functional to the heat and light may be used. Because the surface of the substrate P is made liquid repellent, the droplet 29a is easily rejected so that the droplet is easily deformed to be dorm-shaped.

In the next process of forming an ellipsoid-shaped droplet, the microlens material is ejected again from the droplet ejection head 1 so that a droplet 29b is disposed (refer to FIG. 5B). The droplet 29b is disposed in the vicinity of the droplet 29a on the substrate P before the droplet 29a becomes rigid. If the droplet 29b is slightly displaced from the position of the droplet 29a, i.e., the droplet 29b partially overlays the droplet 29a, the droplets 29a and 29b merge together so that the resulting droplet may be easily ellipsoid shaped. This is because the droplets 29a and 29b are displaced in position from each other.

Lastly, in the process of curing the ellipsoid-shaped droplet, the curing treatment is applied to keep the shape of the microlens material disposed on the substrate P. As a result, the ellipsoid-shaped microlens 30 is formed (refer to FIGS. 5C and 5D). Herein, the substrate P is formed thereon with a liquid repellent layer H1 being liquid repellent. Thereafter, the microlens 30 is plurally formed so that the microlens array 35 is formed, in which the major axes 6 of the microlenses 30 are sloped against the major axes of the linear lamps 41 (refer to FIG. 2).

### Second Formation Method

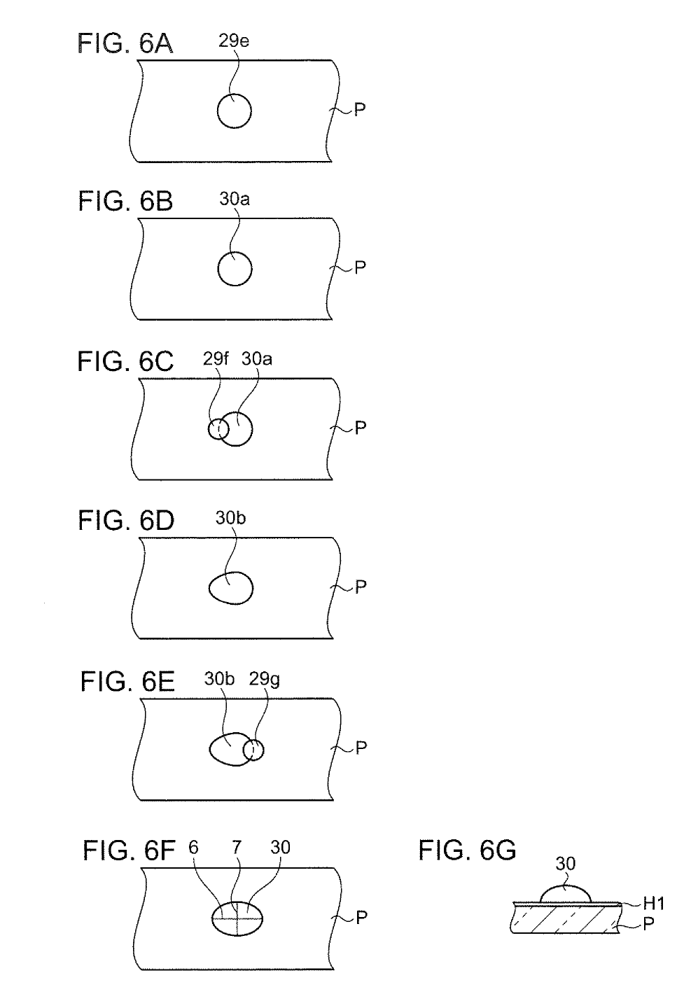

FIGS. 6A to 6G are all a diagram showing the formation method for the ellipsoid-shaped microlens 30. By referring to FIGS. 6A to 6G, described is the formation method of the ellipsoid-shaped microlens 30. Any similar details from the first formation method are not described here, i.e., the microlens material, and techniques for surface treatment, droplet disposition, curing treatment, and others. The second formation method includes processes of disposing a lens-material first droplet on a substrate, forming a lens by curing the first droplet, disposing a second droplet less in amount than the first droplet to partially overlay the lens, forming an ellipsoid-shaped lens by curing the second droplet, disposing a third droplet at the position opposite to the second droplet to partially overlay the ellipsoid-shaped lens, and curing the third droplet.

In the second formation method, similarly to the first formation method, the substrate P is washed, and the surface of the substrate P is made liquid repellent.

In the next process of disposing the lens-material first droplet, the microlens material is ejected on the liquid-repellent substrate P from the droplet ejection head 1 so that a droplet 29e is disposed (refer to FIG. 6A).

In the next process of forming a lens by curing the first droplet, the droplet 29e is made rigid so that a lens 30a is formed (refer to FIG. 6B).

In the process of disposing the second droplet to partially overlay the lens, a droplet 29f is so disposed as to overlay the lens 30a (refer to FIG. 6C). Because the droplet 29f is less in amount than the droplet 29e, the droplet 29f is smaller in size than the droplet 29e. Although not shown in detail, after the droplet 29f is disposed, the droplet 29f is spread out, and is substantially ellipsoid shaped.

In the process of forming an ellipsoid-shape lens by curing the second droplet, the droplet 29f is made rigid so that a substantially ellipsoid-shaped lens 30b is formed (refer to FIG. 6D).

In the process of disposing a third droplet, a droplet 29g is so disposed as to overlay the lens 30b (refer to FIG. 6E). Because the droplet 29g is less in amount than the droplet 29e, the droplet 29g is smaller in size than the droplet 29e. Although not shown in detail, after the droplet 29g is disposed, the droplet 29g is spread out, and is substantially ellipsoid shaped.

Lastly, in the process of curing the third droplet, after the droplet 29g is made rigid, the ellipsoid-shaped microlens 30 is formed (refer to FIGS. 6F and 6G). Herein, the substrate P is formed thereon with a liquid repellent layer H1 being liquid repellent. Thereafter, the microlens 30 is plurally formed so that the microlens array 35 is formed, in which the major axes 6 of the microlenses 30 are sloped against the major axes of the linear lamps 41 (refer to FIG. 2).

### Third Formation Method

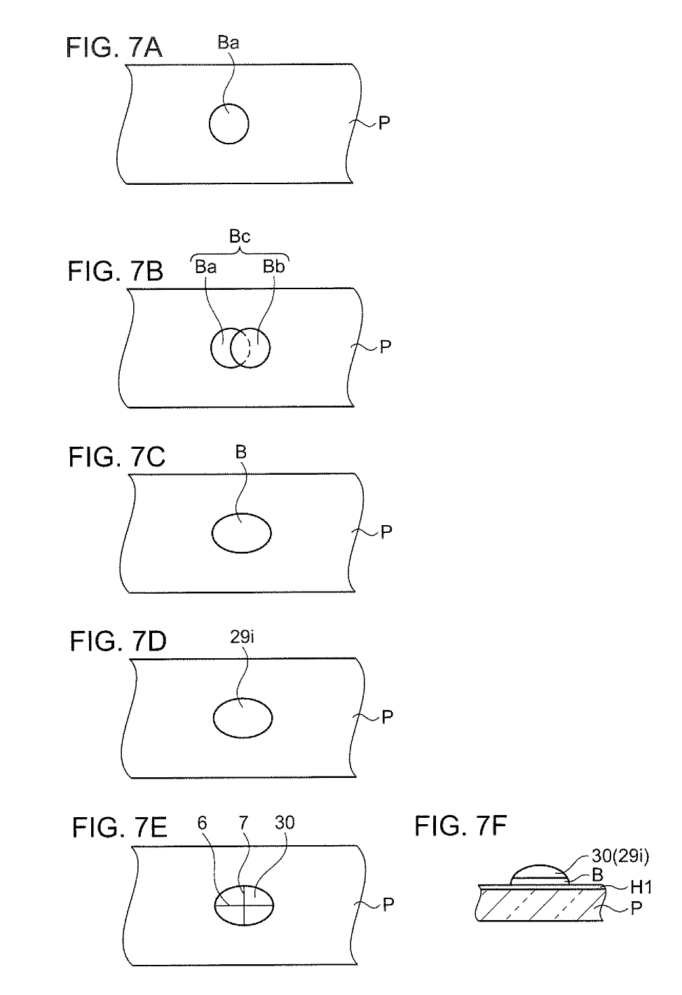

FIGS. 7A to 7F are all a diagram showing the formation method for the ellipsoid-shaped microlens 30. By referring to FIGS. 7A to 7F, described is the formation method of the ellipsoid-shaped microlens 30. The third formation method includes processes of disposing a bank-material first droplet on a substrate, forming an ellipsoid-shaped base by curing the first droplet disposed on the substrate, disposing a lens-material second droplet on the ellipsoid-shaped base, and curing the second droplet.

In the third formation method, similarly to the first formation method, the substrate P is washed, and the surface of the substrate P is made liquid repellent.

In the process of disposing a bank-material first droplet, a bank-material is ejected on the liquid-repellent substrate P from the droplet ejection head 1 so that a droplet Ba is disposed (refer to FIG. 7A). The requirements for such droplet ejection are the weight of a droplet being 4 ng/dot, and the speed of a droplet, i.e., ejection speed, being 5 to 7 m/sec, for example. The atmosphere for droplet ejection is preferably set to the temperature of 60 degrees or lower, and the humidity of 80% or lower. If such requirements are satisfied, the droplet ejection can be performed with stability with no clogging of an ejection nozzle of the droplet ejection head 1.

Next, the bank material is ejected again from the droplet ejection head 1 so that a droplet Bb is disposed (refer to FIG. 7B). The droplet Bb is disposed in the vicinity of the droplet Ba disposed on the substrate P before the droplet Ba becomes rigid. If the droplet Bb is slightly displaced from the position of the droplet Ba, i.e., the droplet 29b partially overlays the droplet Ba, the droplets Ba and Bb merge together so that a droplet Bc is easily ellipsoid shaped because the droplets Ba and Bb are displaced in position from each other.

Thereafter, in the process of forming an ellipsoid-shaped base, after the solvent of the droplet Bc disposed on the substrate P is volatilized (vaporized) for drying and then cured, an ellipsoid-shaped bank B is formed (refer to FIG. 7C). Here, the bank B may be subjected to the liquid repellent treatment. If the surface of the bank B is made liquid repellent, the microlens material to be disposed on the bank B is prevented from overflowing from the surface of the bank B.

In the next process of disposing a lens-material second droplet to the ellipsoid-shaped base, the microlens material is ejected from the droplet ejection head 1 onto the ellipsoid bank B formed on the substrate P so that a droplet 29i is disposed (refer to FIG. 7D). The droplet 29i of the microlens material is ellipsoid shaped.

Lastly, in the process of curing the second droplet, after the droplet 29i is made rigid, the ellipsoid-shaped microlens 30 is formed (refer to FIGS. 7E and 7F). Herein, the substrate P is formed thereon with a liquid repellent layer H1 being liquid repellent. Thereafter, the microlens 30 is plurally formed so that the microlens array 35 is formed, in which the major axes 60 of the microlenses 30 are sloped against the major axes of the linear lamps 41 (refer to FIG. 2).

### Fourth Formation Method

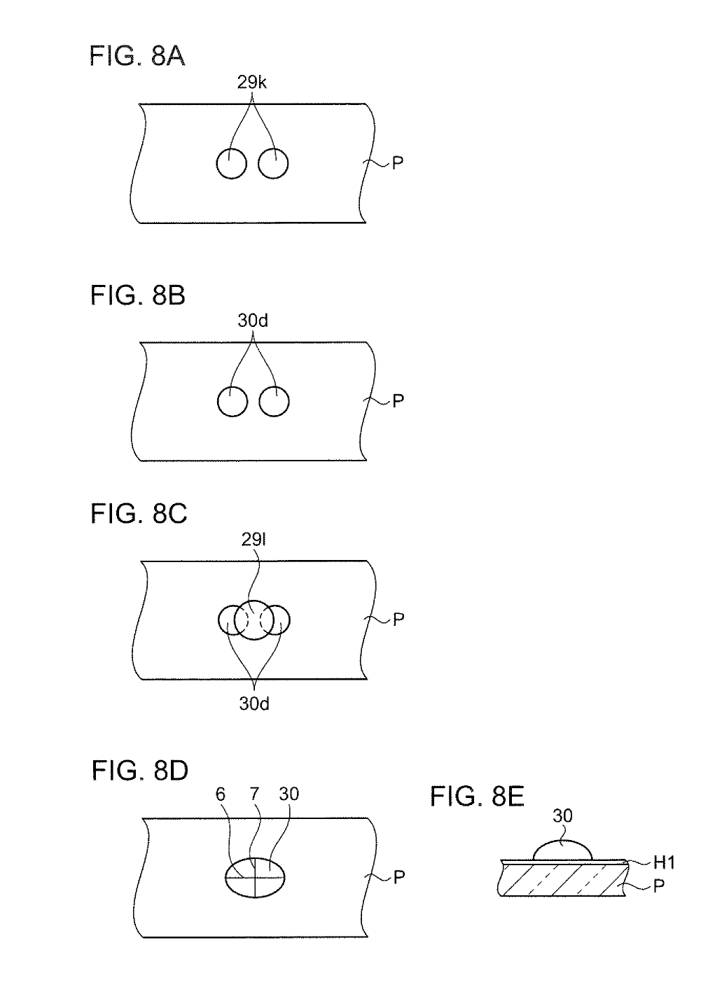

FIGS. 8A to 8E are all a diagram showing the formation method for the ellipsoid-shaped microlens 30. By referring to FIGS. 8A to 8E, described is the formation method of the ellipsoid-shaped microlens 30. The fourth formation method includes processes of disposing a plurality of lens-material droplets with a space on a substrate, forming a plurality of lenses by curing the droplets, disposing other droplets between the lenses, and curing the droplets.

In the fourth formation method, similarly to the first formation method, the substrate P is washed, and the surface of the substrate P is made liquid repellent.

In the process of disposing a plurality of lens-material droplets with a space, on the liquid-repellent substrate P, a microlens material is ejected from the droplet ejection head 1 so that a plurality of droplets 29k are disposed, e.g., two in this example (refer to FIG. 8A).

In the next process of forming a plurality of lenses by curing the droplets, the droplets 29k are made rigid so that lenses 30d are formed (refer to FIG. 8B).

In the process of disposing the droplets, a droplet 291 is so disposed as to cover the space between the lenses 30d (refer to FIG. 8C). After disposed, the droplets 29l are spread, and are substantially ellipsoid shaped. Moreover, if the droplet 29l is made larger in amount than the droplet 29k, the resulting droplet may be easily ellipsoid shaped with better shape precision, and it is considered preferable.

Lastly, in the process of curing the droplets, after the droplet 29l is made rigid, the ellipsoid-shaped microlens 30 is formed (refer to FIGS. 8D and 8E). Herein, the substrate P is formed thereon with a liquid repellent layer H1 being liquid repellent. Thereafter, the microlens 30 is plurally formed so that the microlens array 35 is formed, in which the major axes 6 of the microlenses 30 are sloped against the major axes of the linear lamps 41 (refer to FIG. 2).

The microlenses 30 as a result of such first to fourth formation methods are all formed by droplet ejection. The microlenses 30 formed on the substrate P are thus all convex ellipsoid shaped (refer to FIGS. 1 to 3).

In the present embodiment, the following effects are achieved.

1. With the configuration of the backlight unit 40 in which the microlenses 30 are so disposed as to diagonally intersect the linear Lamps 41 in their major axis directions, the curvature in the minor axes of the microlenses 30 is larger than that in the major axes so that the light is easily diffused in the minor axis direction of the microlenses 30, thereby favorably reducing the intensity variation. On the other hand, the light is hardly diffused in the major axis direction of the microlenses 30, and the light leakage to the outside is reduced so that the lightness is increased no matter if the microlenses are not provided that many. As such, the resulting backlight unit 40 can be with high brightness and varies less in intensity. If the resulting backlight unit 40 can be with high brightness and varies less in intensity as such, there is no need to increase the number of the linear lamps 41 to make those serve as a light source, thereby favorably clearing the problems of heat, cost, and mass of the linear lamps 41. What is better, if the intensity variation is reduced, the linear lamps 41 can be disposed closer to the display surface so that the backlight unit 40 can be successfully lighter in weight and thinner in profile.

2. The linear lamps 41 are disposed between the reflector plate 44 and the diffuser plate 43 so that the light leakage to the outside of the screen can be reduced. The resulting backlight unit can be with high brightness and varies less in intensity.

3. The ellipsoid-shaped microlenses 30 are disposed in a staggered alignment on the substrate P so that the microlenses are to be densely packed on the substrate P. This accordingly increase the light diffusibility to a further extent, and the resulting backlight unit thus can be with high brightness and varies less in intensity.

4. Because the ellipsoid-shaped microlenses 30 are formed by droplet ejection on the substrate P, even if the microlenses are changed in shape (dimension) or layout configuration, there only needs to change the requirements for droplet ejection, thereby requiring little effort. What is better, there is no need to prepare a mold or others as has been previously done every time some shape (dimension) change or position change is made. This accordingly eliminates the necessity and the cost for mold manufacturing, and thus is considered economical.

Described next is a liquid crystal display device 100 serving as an electro-optical device of the invention, using the backlight unit 40 provided with the diffuser plate 43.

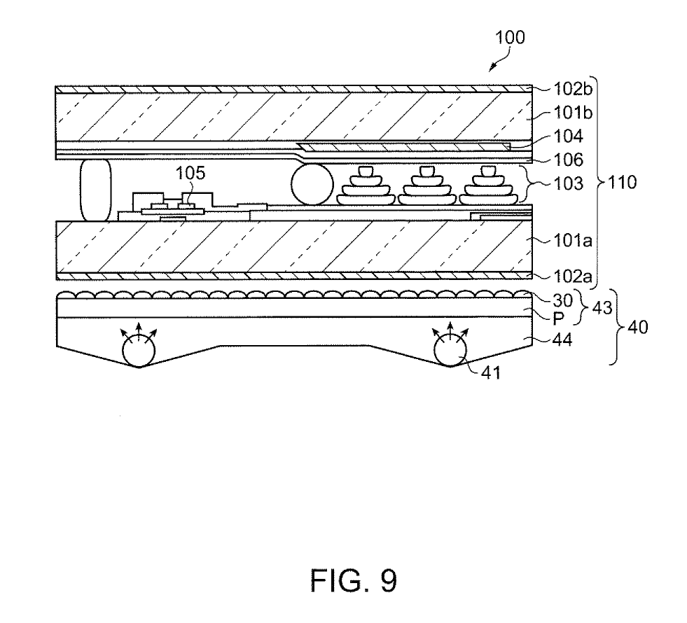

FIG. 9 is a diagram showing the liquid crystal display device 100. In the drawing, the size scaling is not the same between a liquid crystal panel 110 and the backlight unit 40. The liquid crystal display device 100 is configured to include the backlight unit 40, the liquid crystal panel 110, a driver LSI (not shown), and others. The liquid crystal panel 110 is configured by two glass substrates 101a and 101b, two polarizer plates 102a and 102b, a color filter 104, and others. The outside surfaces of the glass substrates 101a and 101b are attached with the polarizer plates 102a and 102b, respectively. The inside surface of the glass substrate 101a is formed with a TFT (thin-film transistor) 105, or others. The inside surface of the glass substrate 101b is formed with the color filter 104, an alignment film 106, and others. Between the glass substrates 101a and 101b, a liquid crystal material 103 is disposed.

The glass substrates 101a and 101b are both transparent substrates configuring the liquid crystal panel 110. The polarizer plates 102a and 102b can pass through or absorb any specific polarizing components. The liquid crystal material 103 can be adjusted by characteristics through mixture of several types of nematic liquid crystal materials. The color filter 104 is a resin film including dyes or pigments of three primary colors of R (red), G (green), and B (blue). The TFT 105 is a drive switching element for driving the liquid crystal material 103. The alignment film 106 is an organic thin film for alignment of the liquid crystal material 103, and a polyimide thin film is popular.

The light coming from the backlight unit 40 passes through the polarizer plate 102a and the glass substrate 101a, and then passes through the liquid crystal material 103, the alignment film 106, and the color filter 104 in order so that predetermined image and videos can be displayed on the liquid crystal panel 110. The liquid crystal display device 100 is provided with the backlight unit 40 having the good optical characteristics and can be reduced in weight and profile so that the resulting liquid crystal display device 100 can have the good optical characteristics and can be reduced in weight and profile. What is better, the diffuser plate 43 including the ellipsoid-shaped microlens 30 is manufactured with ease by droplet ejection so that the productivity of the backlight unit 40 and the liquid crystal display device 100 can be improved.

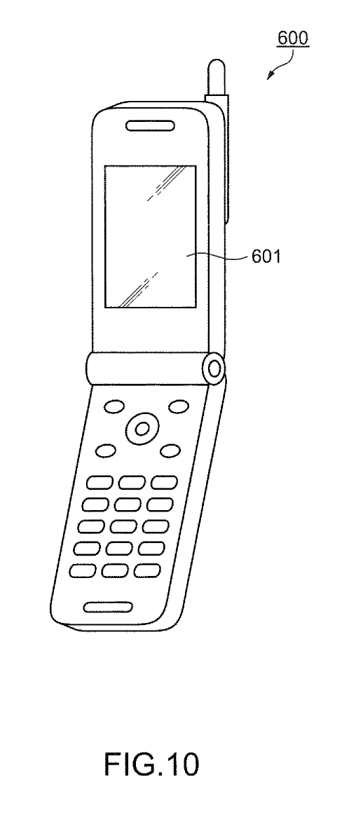

FIG. 10 is a diagram showing an exemplary mobile phone 600 serving as electronic equipment including the liquid crystal display device 100 as the electro-optical device of FIG. 9. FIG. 10 is showing the mobile phone 600 and a liquid crystal display section 601 including the liquid crystal display device 100. The mobile phone 600 is provided with the liquid crystal display device 100 that is with high brightness, varies less in intensity, and can be reduced in weight and profile. Therefore, the resulting mobile phone 600 can serve as electronic equipment that has improved display capability, and can be reduced in weight and profile. What is more, as is including the liquid crystal display device 100 having improved productivity, the productivity of the mobile phone 600 can also be improved.

While the invention has been described in detail with an embodiment, the foregoing description is in all aspects illustrative and not restrictive. It is understood that numerous other modifications and variations as below can be devised without departing from the scope of the invention.

### FIRST MODIFIED EXAMPLE

The backlight unit 40 is of a direct type, including the linear lamps 41 below the diffuser plate 43 in the above-described embodiment. This is surely not restrictive, and the backlight unit 40 may be of a side light type, including the linear lamps 41 on the side surface of the light guiding plate. With this being the case, the intensity variation is easily observed in the direction of the light from the light guiding plate, but the similar effects as the above embodiment are derived. As such, the resulting backlight unit 40 can be with high brightness and varies less in intensity.

SECOND MODIFIED EXAMPLE

The backlight unit 40 has the convex ellipsoid-shaped microlenses 30 in the above embodiment. This is surely not the only option, and the ellipsoid-shaped microlenses 30 may be made concave by utilizing the pinning effects as a result of a coffee stain phenomenon, for example. This also leads to the similar effects as the above embodiment, and the resulting backlight unit 40 can be with high brightness and varies less in intensity.

### THIRD MODIFIED EXAMPLE

The ellipsoid-shaped microlenses 30 formed on the substrate P in the above embodiment are so disposed that their major axis direction is directed from the lower right (upper left) toward the upper left (lower right) of the substrate P of FIG. 2. This is surely not restrictive, and the major axis direction of the microlenses 30 may be directed from the lower left (upper right) to upper right (lower left) of the substrate P of FIG. 2. This also leads to the similar effects as the above embodiment, and the resulting backlight unit 40 can be with high brightness and varies less in intensity.

### FOURTH MODIFIED EXAMPLE

The ellipsoid-shaped microlenses 30 formed on the substrate P in the above embodiment are so disposed as to intersect the linear lamps 41 in their major axis directions with the angle of 45 degrees. This is surely not the only option, and the angle may be 45 degrees or less or more. With the placement with the angle of 45 degrees or less, the major axis direction of the linear lamps 41 is so directed as to form about 90 degrees with the major axis direction of the microlenses 30. This results in a difficulty in light dispersion with the major axis 6 having the smaller curvature so that the brightness can be higher to a further extent. With the placement with the angle of 45 degrees or more, the major axis direction of the linear lamps 41 is so directed as to be parallel with the major axis direction of the microlenses 30. This makes light dispersion easy in the minor axis direction of the microlenses 30 having the larger curvature, whereby the intensity variation can be easily reduced. The resulting backlight unit 40 is of such a type.

### FIFTH MODIFIED EXAMPLE

In the above embodiment, the major axis direction of the ellipsoid-shaped microlenses 30 formed on the substrate P is directed in the same direction. This is surely not restrictive, and some of the ellipsoid-shaped microlenses 30 may be so disposed as to substantially orthogonal to the remaining microlenses 30. This also leads to the similar effects as the above embodiment, and the resulting backlight unit 40 can be with high brightness and varies less in intensity.

### SIXTH MODIFIED EXAMPLE

In the above embodiment, the major axis direction of the ellipsoid-shaped microlenses 30 formed on the substrate P is directed in the same direction. This is surely not restrictive, and some sphere-shaped microlenses may be mixed for disposition, for example. This also leads to the similar effects as the above embodiment, and the resulting backlight unit 40 can be with high brightness and varies less in intensity.

### SEVENTH MODIFIED EXAMPLE

In the above embodiment, the ellipsoid-shaped microlenses 30 formed on the substrate P are all in the same size. This is surely not restrictive, and some size-varying ellipsoid-shaped microlenses may be mixed for disposition. This also leads to the similar effects as the above embodiment, and the resulting backlight unit 40 can be with high brightness and varies less in intensity.

### EIGHTH MODIFIED EXAMPLE

In the above embodiment, the ellipsoid-shaped microlenses 30 are all formed by droplet ejection. This is surely not restrictive, and the ellipsoid-shaped microlenses 30 may be formed using a mold or others, for example. This also leads to the similar effects as the above embodiment, and the resulting backlight unit 40 can be with high brightness and varies less in intensity.

What is claimed is:

1. A backlight unit, comprising:
a light source emitting a light; and
a diffuser plate that diffuses the light coming from the light source, wherein
the diffuser plate is
provided with a plurality of ellipsoid-shaped microlenses, and
disposed to make the microlenses and the light source intersect each other in each major axis direction.

2. The backlight unit according to claim 1, wherein
the backlight unit is of a direct type.

3. The backlight unit according to claim 1, wherein
the microlenses are disposed in a staggered alignment.

4. The backlight unit according to claim 1, wherein
the microlenses are formed by droplet ejection.

5. A manufacturing method of a backlight unit including a light source emitting a light, and a diffuser plate that diffuses the light coming from the light source, the method comprising:
forming the diffuser plate provided with a plurality of ellipsoid-shaped microlenses, and
assembling the backlight unit with a disposition that the microlenses and the light source intersect each other in each major axis direction.

6. The backlight unit manufacturing method according to claim 5, wherein
in the assembling the backlight unit,
the backlight unit is assembled to be of a direct type.

7. The backlight unit manufacturing method according to claim 5, wherein
in the forming the diffuser plate,
the microlenses are disposed in a staggered alignment.

8. The backlight unit manufacturing method according to claim 5, wherein
in the forming the diffuser plate,
the microlenses are formed by droplet ejection.

9. A diffuser plate for diffusing a light, comprising
a plurality of ellipsoid-shaped microlenses, wherein
the ellipsoid-shaped microlenses are disposed to direct in each different direction.

10. An electro-optical device including a liquid crystal panel and a backlight unit, comprising the backlight according to claim 1.

11. An electronic device comprising the electro-optical device of claim 10.
